(19) United States
(12) Patent Application Publication
(10) Pub. No.: US 2009/0299850 A1
(43) Pub. Date: Dec. 3, 2009

(54) COMPUTING SYSTEM AND COMPUTER-IMPLEMENTED METHOD OF PROVIDING TARGETED ADVERTISEMENT USING ACCOUNT SPACE

(75) Inventor: Sangil Shim, Seongnam (KR)

Correspondence Address: H.C. PARK & ASSOCIATES, PLC, 8500 LEESBURG PIKE, SUITE 7500, VIENNA, VA, 22182, US

(73) Assignee: NHN CORPORATION, Seongnam (KR)

(21) Appl. No.: 12/475,477

(22) Filed: May 30, 2009

(30) Foreign Application Priority Data
May 30, 2008 (KR) 10-2008-0050969

(51) Int. Cl. G06Q 30/00; G06Q 10/00

(52) U.S. Cl. 705/14.42; 705/14.49; 705/14.52; 705/14.58; 705/14.66; 705/14.69

(57) ABSTRACT

A computing system and computer-implemented method of providing a targeted advertisement using an ACCOUNT SPACE are provided. The computing system may include: a target setting unit to set a plurality of advertisement targets and combine some or all of the advertisement targets, an object setting unit to set an advertisement target object based on the combined advertisement targets; and a content connection unit to connect (correlate) an advertisement content to (with) the advertisement target object.

### CROSS-REFERENCE TO RELATED APPLICATION

This application claims the benefit of Korean Patent Application No. 10-2008-0050969, filed on May 30, 2008, the entire disclosure of which is incorporated herein by reference.

### BACKGROUND

1. Technical Field

The present disclosure relates to a computing system and computer-implemented method of providing a targeted advertisement using an ACCOUNT SPACE.

2. Background Art

In the past, advertising was made mostly through media, which unilaterally provides advertisement messages, such as a billboard, a television, and a radio. Along with the recent development of network technologies, online advertising that provides a user (customer) with an advertisement on a web page displayed when the user is connected via a network has increased.

In conventional online advertising methods, a key condition in the advertisement agreement between an advertiser and an advertisement provider is an advertisement exposure condition that can guarantee an advertisement to be exposed to users a predetermined number of times. Accordingly, the amount of exposure of a web page including an advertisement is required to be accurately predicted.

Such conventional online advertising methods provide an advertisement not to targeted users but to all users who connect a web page containing the advertisement. Accordingly, the advertisement is exposed to the users whom the advertiser wants to target in a less amount than the one expected by the advertiser.

There is thus a need for a method and system which may provide an advertisement to users targeted by an advertiser, predict the amount of exposure of the advertisement with respect to the targeted users, and billing to the adviser based on the predicted exposure amount.

### BRIEF SUMMARY

One object of the present invention is to provide a computing system, a computer-implemented method, and a computer-readable medium for targeted advertising, which can provide an ACCOUNT SPACE (i.e., an advertising space where a plurality of advertisement contents provided by an advertiser may be registered), enable the advertiser paying for the ACCOUNT SPACE to register the plurality of advertisement contents, and present different advertisement contents in a single advertisement region.

Another object of the present invention is to provide a computing system, a computer-implemented method, and a computer-readable medium for targeted advertising, which can predict a probability that an advertisement is presented to users defined by an advertiser, set a region for the advertisement based on the predicted probability, and thereby may increase the probability.

Still another object of the present invention is to provide a computing system, a computer-implemented method, and a computer-readable medium for targeted advertising, which can predict a probability that an advertisement is presented to users defined by an advertiser, set a region for the advertisement based on the predicted probability, and thereby may guarantee a predetermined amount of exposure of the advertisement and prevent the advertiser from wasting economic resources despite a low exposure probability due to a relatively small number of users.

According to an aspect of the present invention, there is provided a computing system for providing a targeted advertisement. The system includes a target setting unit, an object setting unit and a content connection unit. The target setting unit may set a plurality of advertisement targets and combine some or all of the plurality of advertisement targets. The object setting unit may set an advertisement target object based on the combined advertisement targets. The content connection unit may correlate an advertisement content with the advertisement target object.

According to another aspect of the present invention, there is provided a computer-implemented method of providing a targeted advertisement. The method may comprise: setting a plurality of advertisement targets; combining some or all of the plurality of advertisement targets; setting an advertisement target object based on the combined advertisement targets; and correlating an advertisement content with the advertisement target object.

According to still another aspect of the present invention, there is provided a computer program product in a computer readable medium for providing a targeted advertisement. The product may comprise: a program code for setting a plurality of advertisement targets; a program code for combining some or all of the advertisement targets; a program code for setting an advertisement target object based on the combined advertisement targets; and a program code for correlating an advertisement content with the advertisement target object.

The above and other aspects/features of the present invention are discussed infra.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a configuration of a computing system for providing a targeted advertisement according to an embodiment of the present invention;

FIGS. 2A to 2D illustrate examples of web pages presented by a computing system for providing a targeted advertisement according to an embodiment of the present invention;

FIG. 3 is a flowchart illustrating a computer-implemented method of providing a targeted advertisement according to an embodiment of the present invention;

FIG. 4 is a flowchart illustrating an operation of grouping areas according to an embodiment of the present invention; and

FIG. 5 illustrates an example of a screen presented by a computer-implemented method of providing a targeted advertisement according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

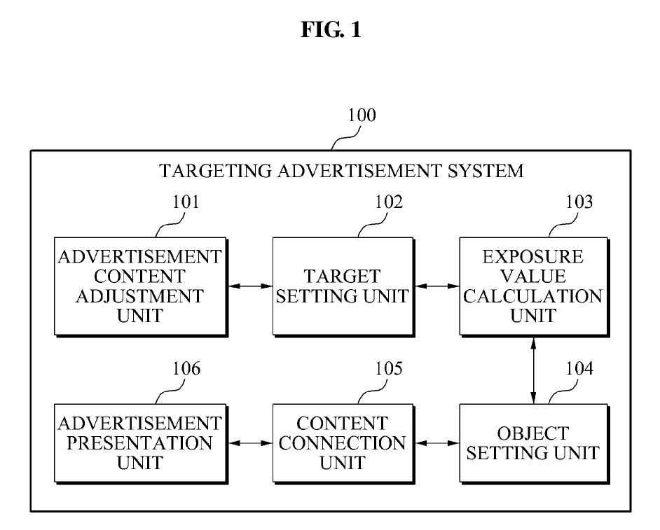

FIG. 1 illustrates a configuration of a computing system 100 for providing a targeted advertisement according to an embodiment of the present invention.

Referring to FIG. 1, in the computing system 100 for providing a targeted advertisement (hereinafter, referred to as ‘computing system’), an advertisement content adjustment unit 101 adjusts the number of advertisement contents, and a target setting unit 102 sets a plurality of advertisement targets and/or combine some or all of the set targets. An exposure value calculation unit 103 calculates a predicted exposure (amount) value as to the combined advertisement targets. An object setting unit 104 sets an advertisement target object based on the calculated predicted exposure value. A content connection unit 105 connects/correlates an advertisement content to/with the advertisement target object.

The advertisement content adjustment unit 101 may register a plurality of advertisement contents provided by an advertiser in a single advertisement region. Also, the advertisement content adjustment unit 101 may change a unit price of an advertisement based on the number of advertisement contents registered by the advertiser.

The advertisement region, that is, advertising space where the plurality of advertisement contents provided by the advertiser may be registered is herein referred to as an ACCOUNT SPACE. Here, at least two advertisement contents may be registered in the ACCOUNT SPACE.

The target setting unit 102 may set and store a plurality of advertisement targets with respect to an object desired by the advertiser, and combine and store some or all of the advertisement targets. For example, the target setting unit 102 may set and store an area target to select a predetermined area, a sex target to select a sex, an age target to select a predetermined age, an education target to select a educational background, an ethnicity target to select a race, or any combination thereof.

The area target, preferably, may be formed by grouping a predetermined number of areas by a predetermined sorting process, thereby facilitating the grouped areas to be targeted. For example, areas may be grouped according to an electoral district, a school district, an administrative district, proximity to a predetermined place/object, or any combination thereof.

The exposure value calculation unit 103 may identify the amount of exposure with respect to users corresponding to the target(s) set by the target setting unit 102 for a predetermined time period. Also, the exposure value calculation unit 103 may calculate a predicted amount of exposure with respect to the users based on the identified amount of exposure.

The object setting unit 104 may set an advertisement target object based on the predicted exposure value. For instance, in case where the area target is included in the combined advertisement targets, the object setting unit 104 may perform grouping as to a predetermined number of areas and set an advertisement target object accordingly. Suitably, the object setting unit 104 may identify area codes of areas that satisfy an area target condition, and put the area codes into a single group to generate a local district, and set an area code of the local district as the advertisement target object.

The content connection unit 105 may correlate the advertisement contents registered in the advertisement content adjustment unit 101 with the advertisement target objects set by the object setting unit 104.

The advertisement presentation unit 106 may store the advertisement target objects and the advertisement contents correlated therewith. In this instance, the advertisement presentation unit 106 may determine which advertisement target object a user connected to a web page belongs to and display on the web page an advertisement content correlated with the identified advertisement target object.

Preferably, the advertisement presentation unit 106 may record, in advance, browser-login mapping information which may be obtained by mapping browser cookie information and login cookie information, and identify from the browser-login mapping information user profile information of a web browser connected to an advertising server. Accordingly, the advertisement presentation unit 106 may determine an advertisement target object corresponding to the user profile information, and provide an advertisement content correlated with the advertisement target object.

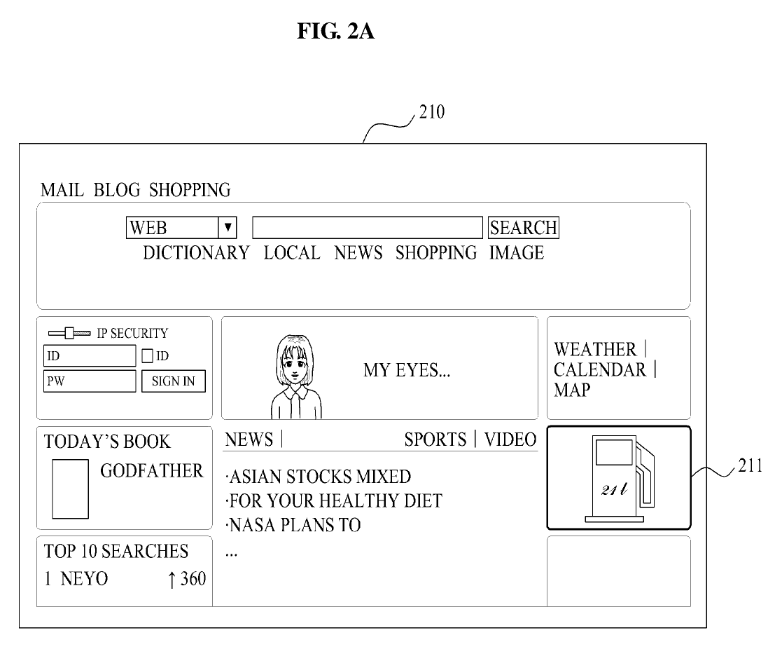

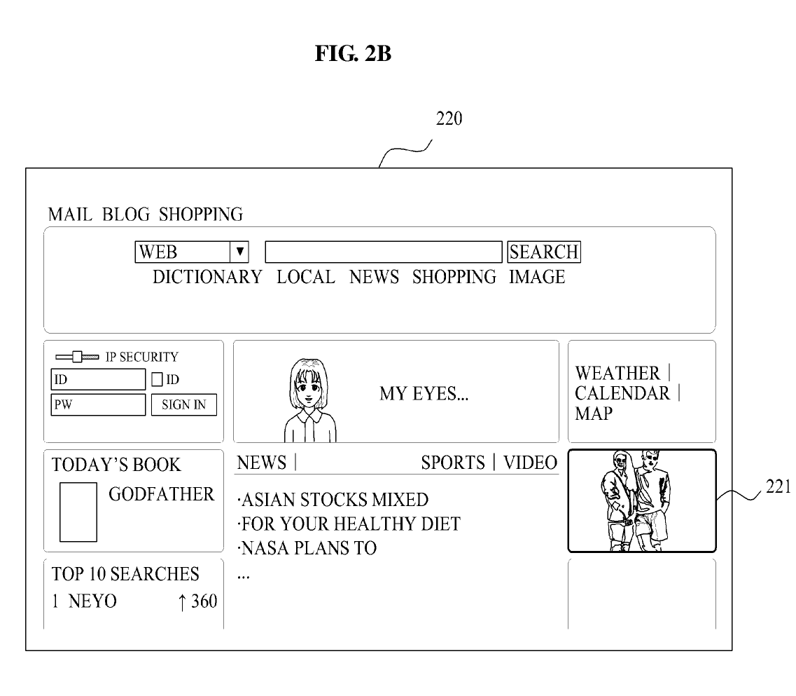

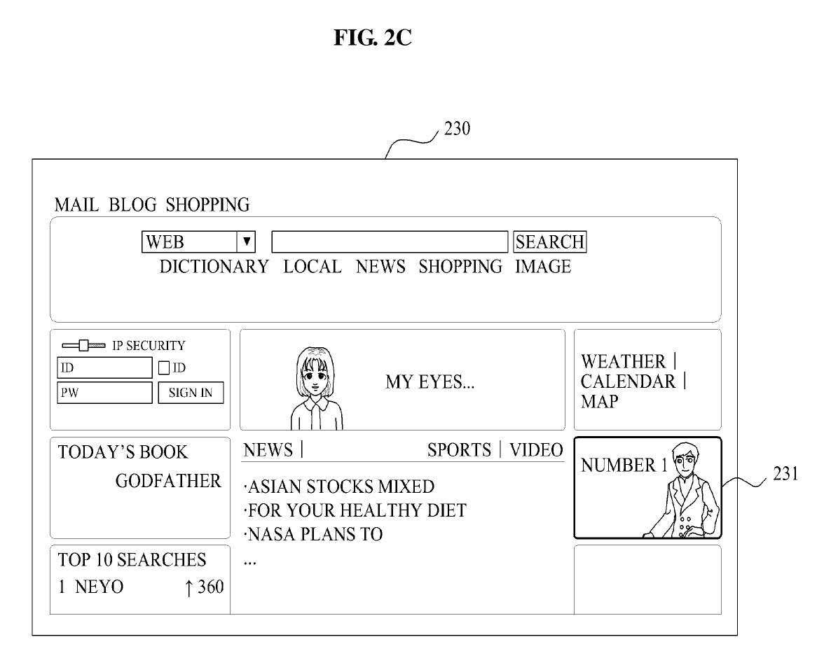

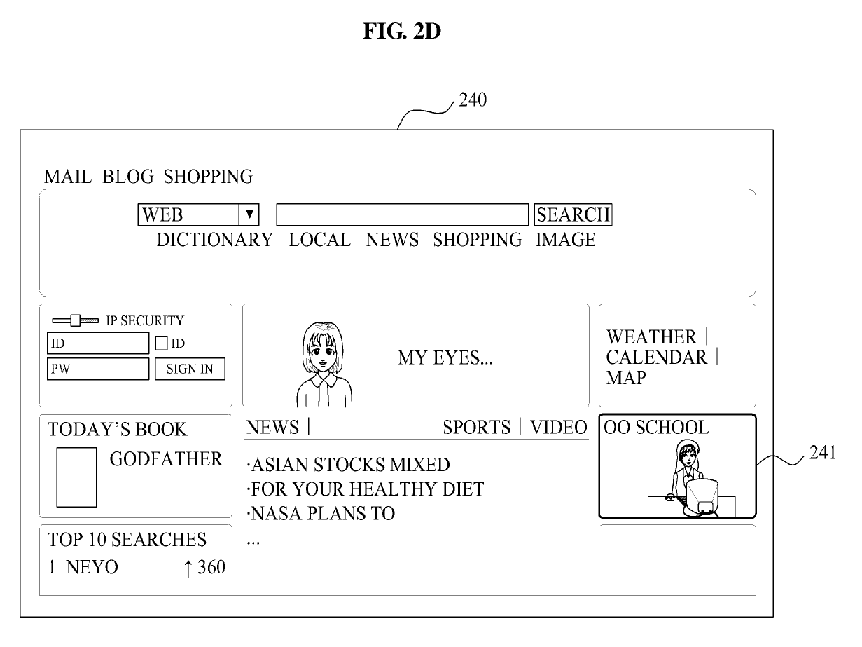

FIG. 2 illustrates examples of web pages presented by a computing system 100 according to an embodiment of the present invention.

As discussed above, a plurality of advertisement targets can be set and some or all of the advertisement targets can be combined. FIG. 2 shows an example of web pages presented by the computing system 100 in which combined advertisement targets are used. More specifically, the computing system 100 includes a first target object, a second target object, a third target object, and a fourth target object. The first target object may be formed by combining three targets (i.e., area, age and sex); e.g., New York City, twenties through thirties, and male. The second target object may be formed by combining two targets (i.e., area and sex); e.g., L.A. and female. The third target object may be formed by combining two targets (i.e., area and electoral district); e.g., Chicago and a particular electoral district X (by county or town). The fourth target object may be formed by combining two targets (i.e., area and school district); e.g., Philadelphia and a particular school Y. In this instance, for example, the first target object, the second target object, the third target object, and the fourth target object may be correlated with an advertisement content of a gas station, women's clothing, an election in the electoral district X, and schools in the school district Y, respectively.

Referring to FIG. 2A, if a user connects to a web page from New York City, the computing system 100 may determine whether the user belongs to the first target object. When it is determined that the user belongs to the first target object, the computing system 100 may provide the user with a web page 210 containing an advertisement content 211 of the gas station.

Referring to FIG. 2B, if a user connects to a web page from L.A., the computing system 100 may determine whether the user belongs to the second target object. When it is determined that the user belongs to the second target object, the computing system 100 may provide the user with a web page 220 containing an advertisement content 221 of the women's clothing.

Referring to FIG. 2C, if a user connects to a web page from Chicago, the computing system 100 may determine whether the user belongs to the third target object. When it is determined that the user belongs to the third target object, the computing system 100 may provide the user with a web page 230 containing an advertisement content 231 of the electoral district X.

Referring to FIG. 2D, if a user connects to a web page from Philadelphia, the computing system 100 may determine whether the user belongs to the fourth target object. When it is determined that the user belongs to the fourth target object, the computing system 100 may provide the user with a web page 240 containing an advertisement content 241 of school(s) in the school district Y.

As described above, the computing system 100 using an ACCOUNT SPACE may provide an appropriate advertisement from among a plurality of advertisement contents depending on a user connected to a web page including an advertisement region contracted by an advertiser.

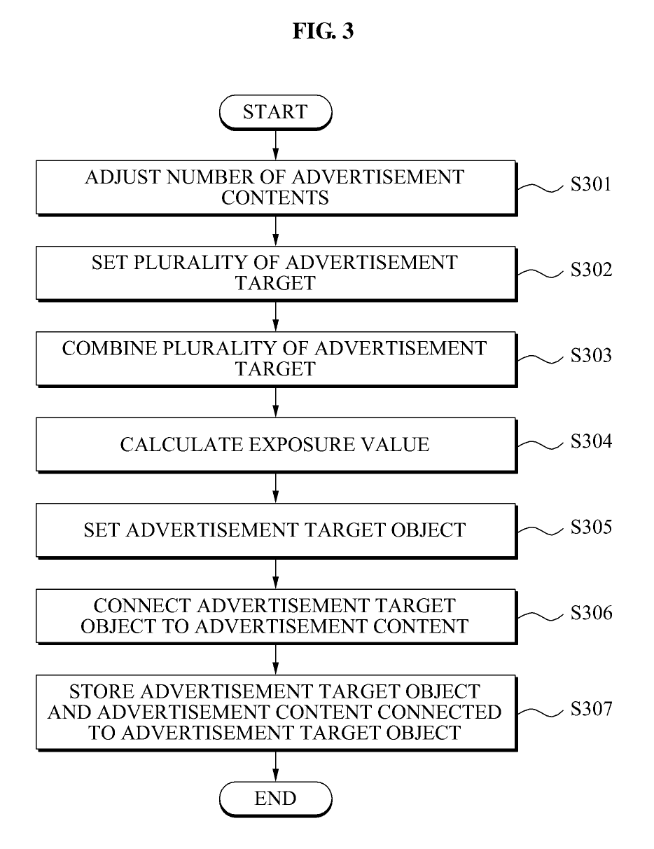

FIG. 3 is a flowchart illustrating a computer-implemented method of providing a targeted advertisement according to an embodiment of the present invention.

In operation S301, the advertisement content adjustment unit 101 may register a number of advertisement contents registered in an ACCOUNT SPACE.

Preferably, the advertisement content adjustment unit 101 may increase or decrease the number of advertisement contents registered in the ACCOUNT SPACE. In this case, depending on the number of advertisement contents, a unit price of an advertisement can be adjusted. For example, when increasing the number of advertisement contents, the advertisement content adjustment unit 101 may increase the unit price; on the other hand, when decreasing the number of advertisement contents, it may decrease.

In operation S302, the target setting unit 102 may set a plurality of advertisement targets. Non-limiting examples of such advertisement targets include an area target to select a predetermined area, a sex target to select a sex, an age target to select a predetermined age, an education target to select an educational background, and an ethnicity target to select a race.

The area target, preferably, may be formed by grouping areas by a predetermined sorting process, thereby facilitating the grouped areas to be targeted. For example, areas may be grouped according to an electoral district, a school district, an administrative district, proximity to a predetermined place/object, or any combination thereof.

In operation S303, the target setting unit 102 may combine some or all of the plurality of advertisement targets set in operation S302. Preferably, the target setting unit 102 may form a certain combination of the advertisement targets based on a request from an advertiser to promote targeted advertising.

In operation S304, the exposure value calculation unit 103 may calculate an exposure value with respect to the combined advertisement targets formed in operation S303. As a non-limiting example, the exposure value calculation unit 103 may measure an exposure value of users corresponding to the advertisement targets set by the target setting unit 102 for a predetermined period of time, and calculate a predicted exposure value of users corresponding to the combined advertisement targets based on the measured exposure value. Also as another non-limiting example, the exposure value calculation unit 103 may measure an exposure value of users corresponding to the combined advertisement targets for a predetermined period of time, and use the value as the predicted exposure value or calculate the predicted exposure value by, e.g., giving a weight to the measured exposure value.

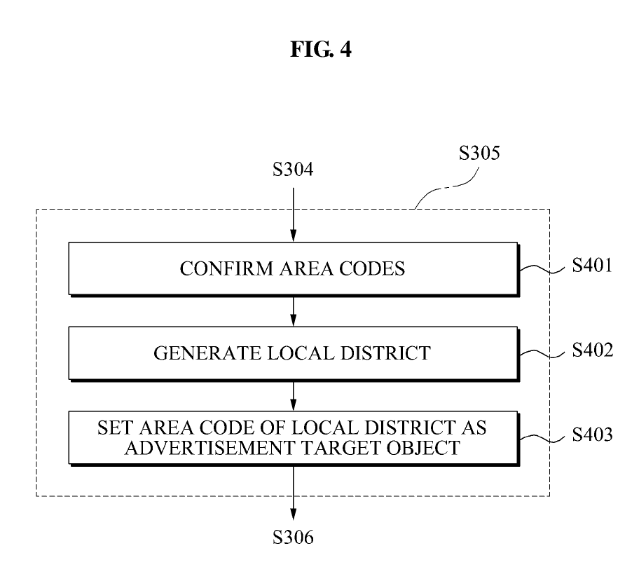

In operation S305, the object setting unit 104 may set an advertisement target object based on the predicted exposure value calculated in operation S304. When the area target is included in the combined advertisement targets, the object setting unit 104 may group a predetermined number of areas to set the advertisement target object. An operation of grouping the areas is described below with reference to FIG. 4.

In operation S306, the content connection unit 105 may correlate the advertisement content registered in operation S301 with the advertisement target object set in operation S305. In this instance, the content connection unit 105 may correlate each of the advertisement contents to each of the advertisement target objects.

In operation S307, the advertisement presentation unit 106 may store the advertisement target objects and the advertisement contents correlated therewith, and prepare to transmit the advertisement.

In this instance, the advertisement presentation unit 106 may record, in advance, browser-login mapping information which may be obtained by mapping browser cookie information and login cookie information, and identify from the browser-login mapping information user profile information of a web browser connected to an advertising server. Accordingly, the advertisement presentation unit 106 may determine an advertisement target object corresponding to the user profile information, and provide an advertisement content correlated with the advertisement target object.

The operation of area grouping in S305 is described in greater detail with reference to FIG. 4.

In operation S401, the object setting unit 104 may identify area codes of areas where the advertisement is to be presented.

In operation S402, the object setting unit 104 may put the area codes into a single group by extracting a portion of the area codes from the identified area codes, and thereby may generate a local district. Preferably, the grouping may be performed based on the area target set in operation S302. The grouping may be performed automatically or manually (e.g., by an advertiser or an advertisement provider).

In operation S403, the object setting unit 104 may set an area code of the local district, generated in operation S402, as the advertisement target object. In this instance, If the content connection unit 105 correlates the advertisement content with the advertisement target object, the advertisement content may be correlated with the area code of the local district.

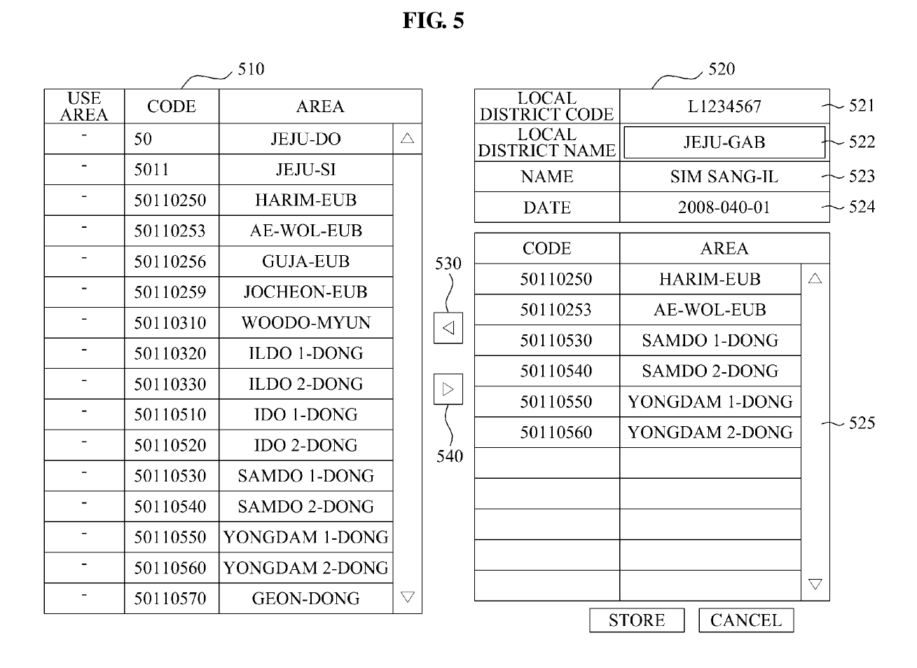

FIG. 5 illustrates an example of a screen presented by a computer-implemented method of providing a targeted advertisement according to an embodiment of the present invention.

The object setting unit 104 may generate an entire area code list 510 of the areas where the advertisement is presented, and a regional area code list 520. The regional area code list 520 may include area codes of areas included in the advertisement target object.

In this instance, the regional area code list 520 may include a local district code 521, a local district name 522, a name of a registrant 523, a date of generation 524, and a set area code list 525. The local district code 521 refers to a code of the advertisement target object, and the local district name 522 refers to a name of the advertisement target object. The name of the registrant 523 refers to a name of a person that registers the advertisement target object. The date of generation 524 refers to a date when the advertisement target object is generated. The set area code list 525 may include set area codes and names of areas included in the advertisement target object.

In this instance, names sorted by the sorting process for the area selection may be used as the local district name 522. For example, when the sorting process for the area selection is based on an electoral district, an electoral district name such as ‘Jeju-gab’ may be used as illustrated in FIG. 5.

Suitably, the object setting unit 104 may further include a removalicon 530 and an additional icon 540. The removal icon 530 may be used to move area codes in the regional area code list 520 to the entire area code list 510. The additional icon 540 may be used to move area codes in the entire area code list 510 to the regional area code list 520.

As described above, the computing system using an ACCOUNT SPACE may enable an advertiser paying for the ACCOUNT SPACE to register a plurality of advertisement contents, and present different advertisement contents in a single advertisement region depending on a user.

Also, the computing system using an ACCOUNT SPACE may predict a probability that an advertisement is presented to users defined by an advertiser, set a region for the advertisement based on the probability, and thereby may increase the probability.

Also, the computing system using an ACCOUNT SPACE may predict a probability that an advertisement is presented to users defined by an advertiser, set a region for the advertisement based on the predicted probability, and thereby may guarantee a predetermined amount of exposure of the advertisement and prevent the advertiser from wasting economic resources despite a low exposure probability due to a relatively small number of users.

The computer-implemented method of providing a targeted advertisement according to the above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

1. A computing system for providing a targeted advertisement, comprising:
a target setting unit to set a plurality of advertisement targets and combine some or all of the plurality of advertisement targets;
an object setting unit to set an advertisement target object based on the combined advertisement targets; and
a content connection unit to correlate an advertisement content with the advertisement target object.

2. The computing system of claim 1, further comprising:
an exposure value calculation unit to calculate an predicted exposure value as to the combined advertisement targets,
wherein the object setting unit sets the advertisement target object based on the calculated exposure value.

3. The computing system of claim 1, further comprising:
an advertisement content adjustment unit to increase the number of advertisement contents, wherein the advertisement content adjustment unit increases a unit price of an advertisement based on an increase in the number of the advertisement contents.

4. The computing system of claim 1, wherein the advertisement target includes an area target to select a predetermined area, a sex target to select a sex, and an age target to select a predetermined age.

5. The computing system of claim 4, wherein the area target is formed by grouping a predetermined number of areas based on a sorting process for an area selection.

6. The computing system of claim 5, wherein the sorting process for the area selection includes at least one of a sorting process based on an electoral district, a sorting process based on a school district, a sorting process based on an administrative district, and a sorting process based on proximity to a predetermined place or object.

7. The computing system of claim 5, wherein the object setting unit groups the predetermined number of areas to set the advertisement target object when the area target is included in the combined advertisement targets.

8. The computing system of claim 7, wherein the object setting unit determines area codes of areas corresponding to an area target condition, and puts the area codes into a single group to generate a local district, and sets an area code of the local district as the advertisement target object.

9. The computing system of claim 1, further comprising:
an advertisement presentation unit to store the advertisement target object and the advertisement content correlated with the advertisement target object.

10. A computer-implemented method of providing a targeted advertisement, comprising:
setting a plurality of advertisement targets;
combining some or all of the plurality of advertisement targets;
setting an advertisement target object based on the combined advertisement targets; and
correlating an advertisement content with the advertisement target object.

11. The method of claim 10, further comprising:
calculating a predicted exposure value as to the combined advertisement targets,
wherein the advertisement target object is set based on the calculated exposure value.

12. The method of claim 10, further comprising:
increasing the number of advertisement contents,
wherein when the number of advertisement contents is increased, a unit price of an advertisement is increased.

13. The method of claim 10, wherein the advertisement target includes an area target to select a predetermined area, a sex target to select a sex, and an age target to select a predetermined age.

14. The method of claim 13, wherein the area target is formed by grouping a predetermined number of areas based on a sorting process for an area selection.

15. The method of claim 14, wherein the sorting process for the area selection includes at least one of a sorting process based on an electoral district, a sorting process based on a school district, a sorting process based on an administrative district, and a sorting process based on whether to be close to a predetermined object.

16. The method of claim 14, wherein the setting of the advertisement target object comprises:
grouping the predetermined number of areas to set the advertisement target object when the area target is included in the combined advertisement targets.

17. The method of claim 16, wherein the grouping comprises:
determining area codes of areas corresponding to an area target condition; putting the area codes into a single group and generating a local district; and setting an area code of the local district as the advertisement target object.

18. The method of claim 10, further comprising:
storing the advertisement target object and the advertisement content correlated with the advertisement target object.

19. A computer program product in a computer readable medium for providing a targeted advertisement, the product comprising:
a program code for setting a plurality of advertisement targets;
a program code for combining some or all of the advertisement targets;
a program code for setting an advertisement target object based on the combined advertisement targets; and
a program code for correlating an advertisement content with the advertisement target object.
